(19) United States
(12) Patent Application Publication
(10) Pub. No.: US 2003/0140666 A1
(43) Pub. Date: Jul. 31, 2003

(54) Building structures

(76) Inventors: John Patrick Darcy, Bedfordshire (GB); Matthew D A Tiller, Warwickshire (GB); Tim Armitage, Bourne Lincolnshire (GB)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/257,720

(22) PCT Filed: Apr. 18, 2001
(86) PCT No.: PCT/GB01/01773

(30) Foreign Application Priority Data
Apr. 20, 2000 (GB) 00097857
Aug. 15, 2000 (GB) 00199224
Mar. 9, 2001 (GB) 01058601

(51) Int. Cl. E05B 53/00; E05B 63/14; E05B 65/36

(52) U.S. Cl. 70/264

(57) ABSTRACT

A central locking system for a building having at least one window or door, the system comprising a central control unit in communication with a storage means for retaining pressurised fluid, the storage means being in fluid communication with at least one locking mechanism operable in response to a signal from the central control unit to the storage means to move between an inoperative position in which the opening and closing of the associated door or window is unimpeded and an operative position in which the opening and closing of the door or window is impeded.

### DESCRIPTION OF INVENTION

This invention relates to a building structure and to a method of installing a control system in a building structure.

It has been proposed, for example in international patent application no WO90/03485 to provide a locking system for a building structure, such as a dwelling or hotel in which locks are controlled from a central control unit, with wiring from the control unit to individual door and window locks of the locking system. The wiring both carries signals to control operation of the locks, but also power to operate the locks. Such an arrangement is preferred to any locking system which may require locks on windows to be powered by batteries, even though wiring to the locks may be eliminated by broadcasting control signals to the locks, because batteries tend not to be replaced regularly, resulting in a mis-functioning of the locking system.

When building a structure, or in the course or major renovations, it may be acceptable to chase wiring for such systems in walls, e.g. from a floor or ceiling to window locks, into plasterwork, but where such a locking system is to be installed in a building structure such as in a home, it may be unacceptable to the occupants for decorations to be damaged by the installation of such wiring. Also, the use of surface mounted conduit to hide such wires may not be acceptable, again particularly in a home.

It is known to install alarm systems in existing buildings which have a plurality of sensors connected via wiring to a central control unit. The wiring for such systems is conventionally hidden beneath floors, above ceilings and under carpets. However, because there is no requirement for wiring to window locks at least alarm wiring can thus be hidden. So called “wireless” alarm systems are also known which do not require wires to be installed between a control unit and sensors/an alarm unit of the system, either relying on broadcast signals, or signals of a frequency other than the mains frequency being carried on mains wiring. Such a system could not be adapted to a locking system where power to locks is to be provided by wiring rather than batteries.

Wiring for telecommunication systems is hidden within a building, although it is also common for such wiring to be run around the exterior of the building structure too. This latter technique would not be acceptable in the case of a locking or other security system.

According to one aspect of the invention I provide a method of providing a control system in a building structure of the kind having an exterior wall structure including an inner wall and an outer wall and a cavity between the inner and outer walls, the system including a central control unit which is connected by control lines to remote operating units including at least one operator input unit, each remote operating unit being located within a boundary of the exterior wall structure, characterised in that the central control unit is situated in a void which extends above an upper level of the cavity between the inner and outer walls, and the method includes installing control lines within the cavity so as to extend between the central control unit and at least some of the remote operating units.

The void in which the central control unit is installed may be a loft space of the building, or where the building structure includes an attic, a space either above a ceiling of the attic or in an attic floor space. In each case, utilising the method of the invention, a control system may be installed in an existing building with minimal interference with existing inner wall decorations and the like as the control lines are conveniently passed down (or up) cavities of the outer wall structure.

The invention may be applied for installing any control system such as, for examples only, a control system of the kind which enables at least one window/door lock remotely to be actuated, in which case at least one of the remote operating units may be a lock which preferably is mounted in a door or window frame and to which access to enable connection with a respective control line to be made, may be direct from the cavity. Such a lock may have a locking bolt which is extendible into engagement with the respective door or window casement in response to, or in the absence of a control signal along the respective control line, from the central control unit.

Alternatively or additionally the invention may be applied for installing a control system of kind which includes at least one fire and/or smoke detector and/or intruder sensor in which case the remote operating unit may include a temperature and/or smoke detector and/or movement and/or infra-red sensor or other intruder sensor which may be mounted on the inner wall of the building structure or a ceiling thereof, and the method may include providing an opening through the inner wall to the cavity and passing the control line therefor through an opening in the inner wall to enable connection to be made to the remote operating unit. Alternatively, where the invention is applied for installing a control system of kind which includes at least one intruder sensor, the intruder sensor may include a contact type sensor which senses when a window or door is open or has been opened or broken, in which case at least one of the remote operating units may be a contact type sensor which preferably is mounted in a door or window frame and to which access to enable connection with a respective control line to be made, may be direct from the cavity.

Further alternatively, the invention may be applied to install a control system which includes a communications terminal, by means of which communication may be made via the central control unit, to other communication terminals of the system internally of the building structure, and/or an external telecommunications network. The communications terminal may be mounted on the inner wall of the building structure, and the method may again include providing an opening through the inner wall to the cavity and passing the control line therefor through an opening in the inner wall to enable connection to be made to the remote operating unit.

Where the control system has both fire/smoke detection functionality and remotely operable locks, the control system may be operated to cause the locks to unlock in the event of detection of a fire/smoke.

Yet further alternatively the invention may be applied to a control system which includes at least one blind/curtain actuating means in which case the actuating means may be the remote operating unit, and the method may include providing a connection between a respective control line and the actuating means by passing the control line through an opening between the inner wall and the cavity.

It will be appreciated that a control system installed by the method of the invention may include remote operating units being locks and/or fire/smoke detectors and/or intruder sensors and/or communications terminals and/or blind/curtain actuating means. In each case the operator input unit may be connected to the central control unit by a control line which is installed in the cavity and extends from the central control unit, to a convenient position within the building for operator input, e.g. adjacent an external door of the building structure.

The operator input unit may include a keypad by means of which an operator may input a secure PIN number to control the system, and/or a key operated lock, and/or a broadcast signal receiving unit, e.g. for receiving infrared/radio or another signal broadcast by an operator to control the system, whereby any remote locks connected to the central control unit may be actuated and de-actuated, and any blind/curtain actuating means may be operated to open/close the blind/curtain, and where the control system includes alarm functionality, the alarm function may be armed and disarmed. Additionally and/or alternatively, the method may include installing a remote control signal receiver unit by means of which control signals, e.g. from a satellite or terrestrial based transmitter, may be provided to the central control unit for controlling the system.

The method of the invention may include installing at least one remote operating unit on or in an internal wall of the building structure, and providing connection thereto from the central control unit via a control line by installing the control line therefor in a cavity of the internal wall from the void in which the central control unit is situated, and/or by installing the control line therefor in the cavity of the external wall structure of the building, through a floor or ceiling space, and through a cavity of the internal wall.

The control lines of the system may include electrical wires for carrying electrical signals, or pipes for carrying operating fluid such as compressed air or even hydraulic fluid.

In the former case, the remote operating units would be electrically operated.

In the latter cases, the method may include installing a fluid pump to pressurise the fluid. The remote operating units connected to the pump thus would be fluid operated. Means may be provided to maintain a fluid pressure in the pipe control lines to maintain a remote operating unit, which may be a lock, in an operative or inoperative condition in opposition to a resilient biasing means such as a spring which is operable to bias the remote operating unit into an inoperative or operative condition respectively.

According to a second aspect of the invention I provide a control system installed in a building structure by the method of the first aspect of the invention.

According to a third aspect of the invention I provide a building structure having installed therein a control system according to the second aspect of the invention.

Known central locking systems for building structures generally employ electrically controlled locks. Although such known systems are generally effective, the size of the electronic control means in comparison with the space available means that the locks provided at each window or door or means for controlling them tend to be visible which is undesirable from an aesthetic view point.

According to a further aspect of the present invention, presented in its broadest form, there is provided a central locking system for a building having at least one window or door, the system comprising a central control unit in communication with a storage means for retaining pressurised fluid, the storage means being in fluid communication with at least one locking mechanism and the locking mechanism being actuable between an inoperative position in which the opening and closing of the associated door or window is unimpeded and an operative position in which the opening and closing of the door is impeded.

The use of pneumatically controlled locking mechanisms is advantageous as it provides a simple yet powerful mechanism for locking the associated door or window to prevent unauthorised entry without affecting the general aesthetic appearance of the window or door or its surrounds.

The majority of PVC-U windows are formed with a euro-groove to accommodate window furniture and other items used in the operation of the window opening and closing mechanism. In a preferred embodiment the locking mechanism comprises a protrusion or abutment surface which is adapted to cooperate with the eurogroove within the window or door sash. Cooperation with the euro-groove is advantageous as it allows the locking mechanism to be fitted to new or existing windows or doors without modification to the existing window or door structure.

To aid accurate location and closing of PVC-U windows or the like, it is known to use sloped abutment surfaces also known as “run-up blocks”. The locking mechanism may be connected to or integrally formed with such a run-up block thereby facilitating manufacture and installation as well as improving the operational efficiency of the window locking unit.

In known PVC-U windows and the like a particularly advantageous improvement was perceived to be the use of “shoot bolts” or rods projecting laterally from either side of the window sash to securely engage in apertures or keeps in the window frame. However, this locking mechanism has proved so secure that it can be dangerous in instances where escape from a window is required and a key or other means for releasing the shot bolts cannot be found. The window is secured so firmly in place that access by the emergency services can be impeded. Thus, contrary to expectation, the pneumatically operated locking means might be used in conjunction with a less secure manually actuable locking means, such as an espagnolette locking system. In the event of emergency, the pneumatically operated locking means can be locally disengaged by operation of a mechanism which allows the pressurised fluid to escape. This escape mechanism is located in the window frame or in the general area of the window. Entry through the window can then be gained by forcing open the remaining manually actuable locking means, and exit through the window can be achieved by releasing any manually actuable locks or, if those locks can not be released or unlocked; forcing the locks.

Alternatively, the pneumatically operated locking mechanism could be used in conjunction with a shoot bolts arrangement by providing a pneumatically actuable keep or retaining mechanism which engages with the protruding shoot bolt. The movable part of this pneumatically operated locking mechanism is contained in the window frame and on movement of the locking mechanism to its inoperative position the window can be moved to an open position despite the protrusion of the shoot bolt from the window. Thus, in this embodiment, the manually operable locking mechanism cooperates directly with the pneumatically operated mechanism such that the window or door can be opened or closed regardless of the position of the manually operable locking mechanism if the pneumatically operated mechanism is in the inoperative position.

In some arrangements, an additional manual lock may be provided, particularly in the area of the handle jam. For instance a central dead bolt or espagnolette locking system may be provided. This additional manual lock would need to be released to allow the window or door to be opened when the pneumatically operated mechanism is released.

According to another advantageous aspect of the present invention, a fail-safe sensor is provided in combination with each pneumatic locking mechanism. If the central locking system is deactivated and a locking mechanism fails to return to its inoperative position, the fail-safe sensor provides a signal indicative of this failure and a visual and/or an audible alarm is sounded. As not all of the windows or doors of a house are used regularly, this fail-safe sensor provides a mechanism for bringing to the attention of the operator any malfunction of the system which could lead to difficulties opening a door or window in the event of an emergency.

Although the present invention is particularly applicable to PVC-U windows using a euro-groove, it could be fitted to any window by the provision of an appropriate groove or slot adjacent the frame of the window and a pneumatically operated projection or formation adapted to cooperate with that groove or slot to prevent the opening or closing of the window or door.

According to another embodiment of the present invention, particularly but not exclusively suited to doors, a pneumatic valve can be provided to move locking means associated with a door from the operative position to the inoperative position. The pneumatic valve is incorporated in the manually actuable door locking mechanism and it is triggered by release of the manually actuable lock to move the pneumatic locking means to the inoperative position. This mechanism would allow access by an authorised person having a key for the main or master door lock if the pneumatically operated locks cannot be deactivated by the normal means.

According to yet another aspect of the present invention there is provided a method of providing a control system in a building structure of the kind having an exterior wall structure including an inner wall and an outer wall and a cavity therebetween, the system including a central control unit in communication with storage means for retaining a pressurised fluid and storage means being in fluid communication with at least one locking mechanism via control lines, the method including the step of installing the control lines at least partially within the cavity.

According to a preferred embodiment, the storage means is located in a void which extends above an upper level of the cavity between the inner and outer wall. The control unit may also be situated in the void. Further, the control lines may be predominately or entirely contained within the cavity to reduce the visual impact of the system.

According to another aspect of the present invention, there is provided a locking mechanism for a building central locking system comprising a pneumatically operated protrusion moveable along a primary axis between an extended and a retracted position in which the locking mechanism respectively impedes and allows the opening and closing of an associated door or window, and a plurality a support means to guide the movement of the protrusion between the extended and the retracted positions, the support means being configured substantially to prevent movement or rotation of the protrusion away from the primary axis.

The aspects of the invention described in the present application may be utilised in combination with the other aspects of the invention described above, and particularly the system may include at least one fire and/or smoke detector which, when fire or smoke is detected, automatically deactivate the pneumatic locking mechanisms to allow safe exit from the building structure and relatively easy access thereto by the emergency services.

According to another aspect of the invention, there is provided a building structure incorporating a central locking system as described above or having a central locking system installed according to the method described above.

The invention will now be described by way of example only with reference to the accompanying drawings of which

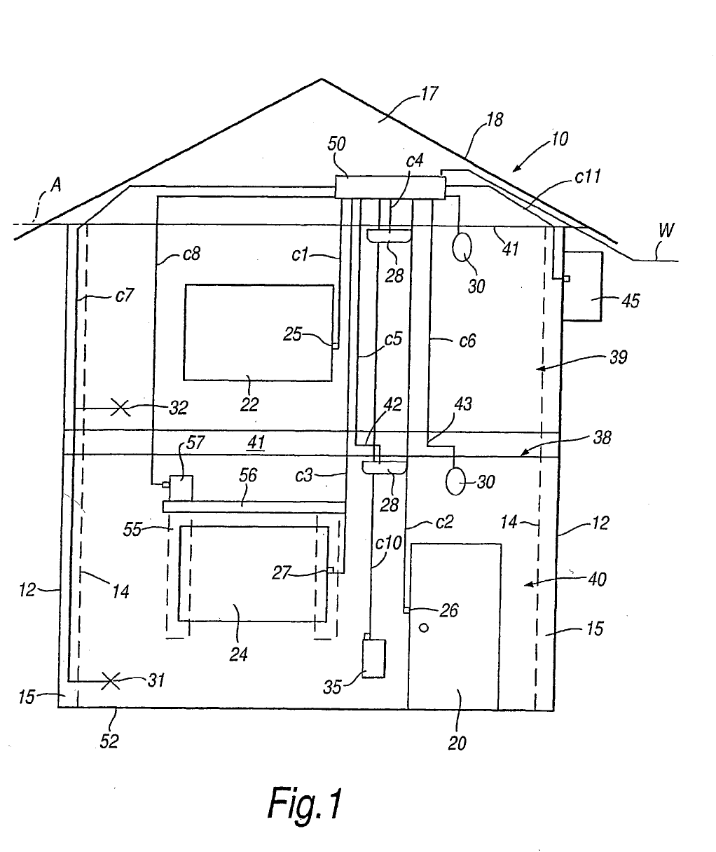

FIG. 1 is a schematic and purely illustrative view of a control system which may be installed and operated in accordance with the invention,

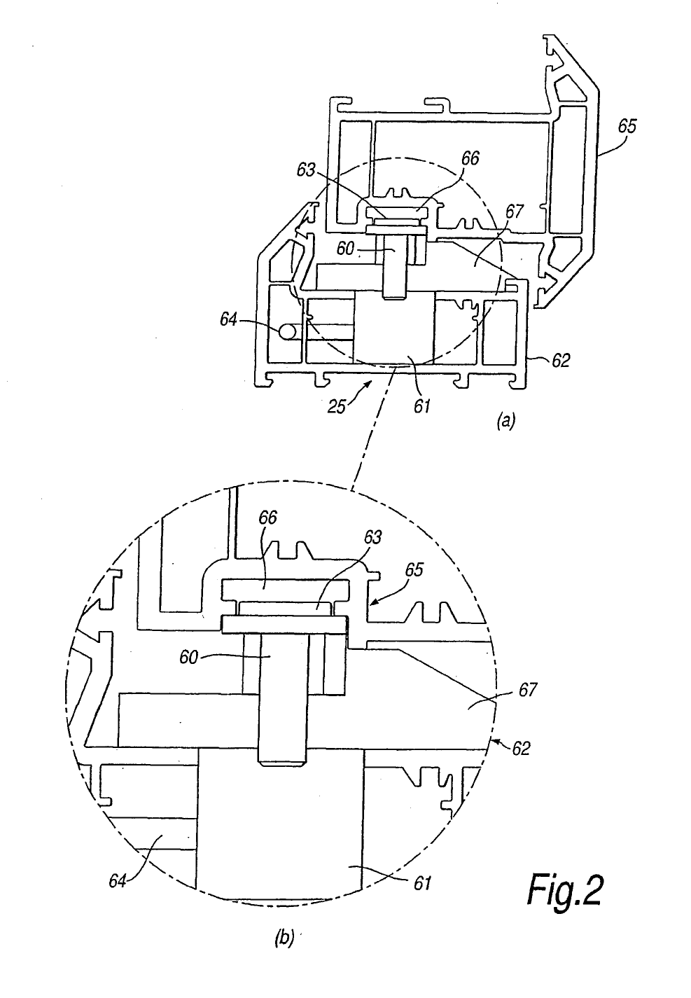

FIG. 2 is an illustration of a pneumatically operated lock which may be operated. by the control system of FIG. 1, shown with the lock in a locked condition,

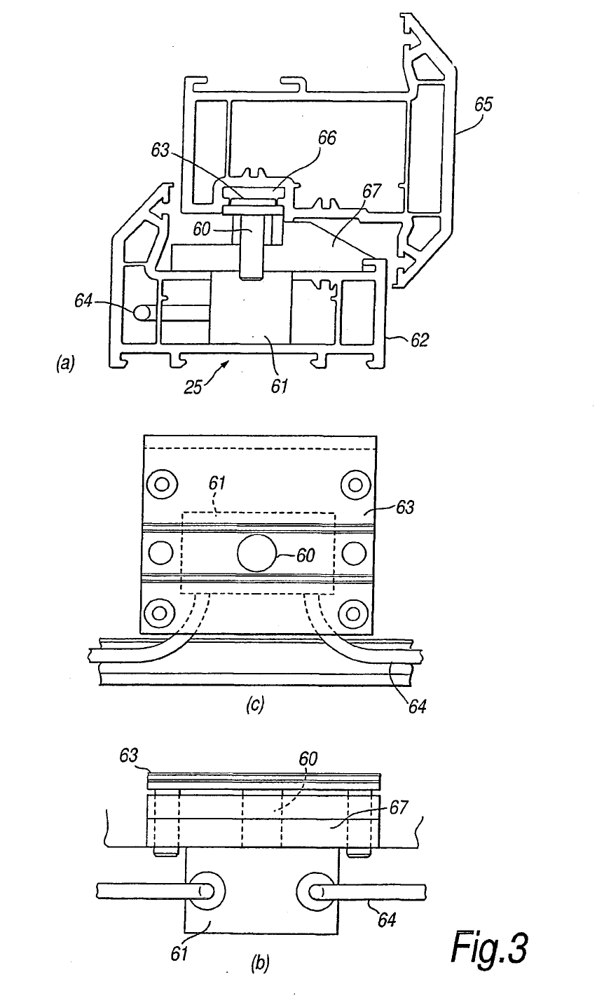

FIG. 3 contains further illustrations of the lock of FIG. 2

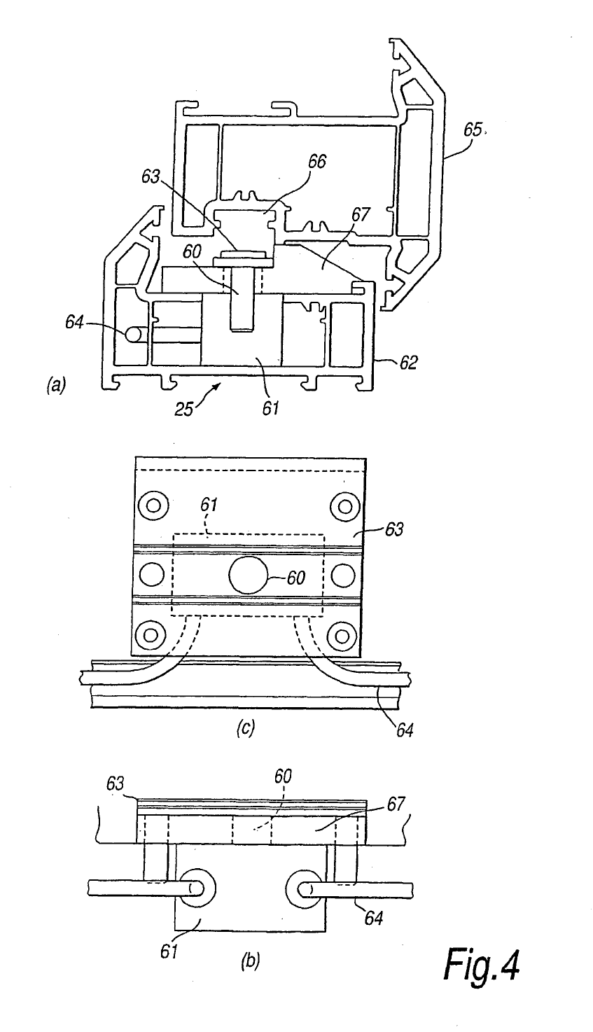

FIG. 4 is an illustration of the pneumatically operated lock of FIG. 2, with the lock in an unlocked condition,

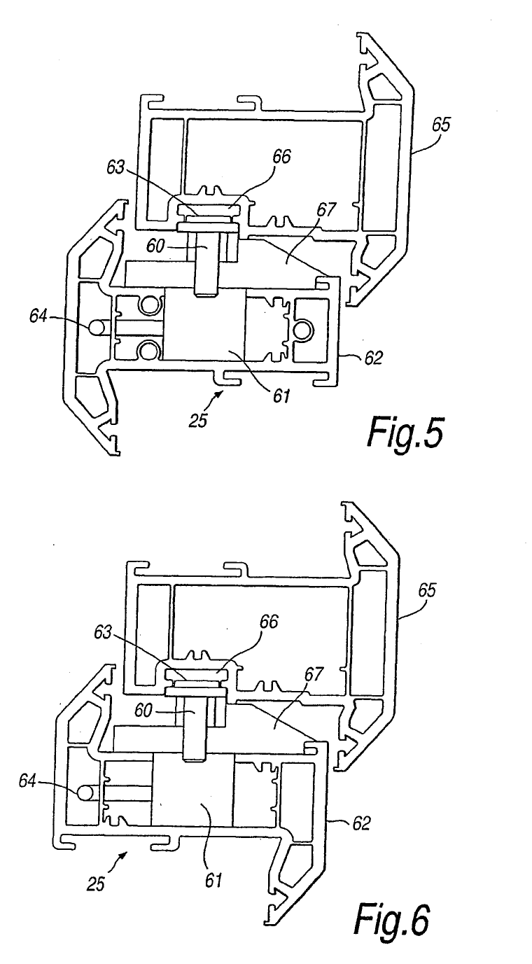

FIG. 5 is an illustration of the pneumatically operated lock of FIG. 2 mounted within a second variety of window or door frame,

FIG. 6 is an illustration of the pneumatically operated lock of FIG. 2 mounted within a third variety of window or door frame,

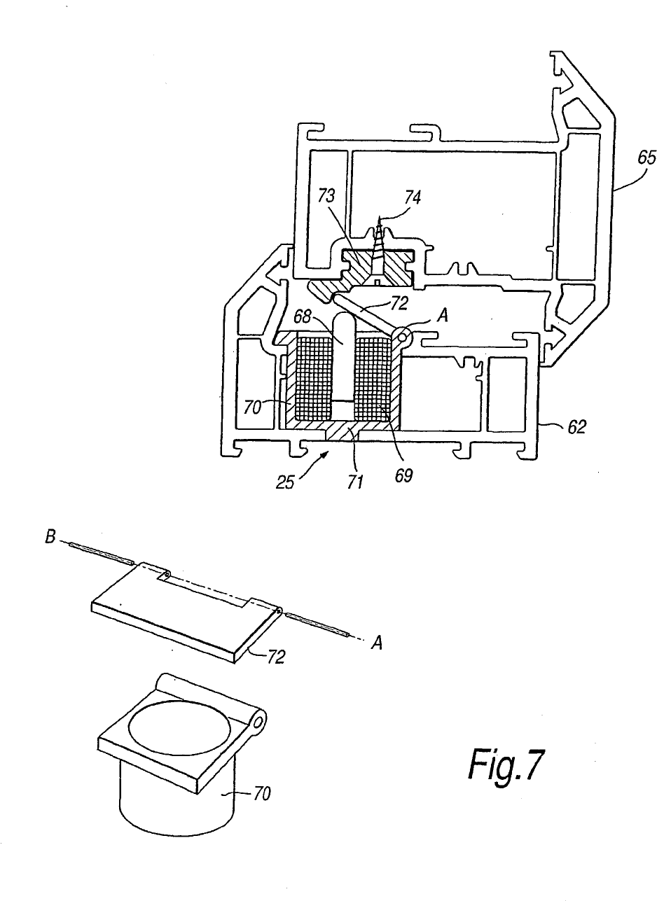

FIG. 7 is an illustration of an electrically operated lock which may be operated by the control system of FIG. 1.

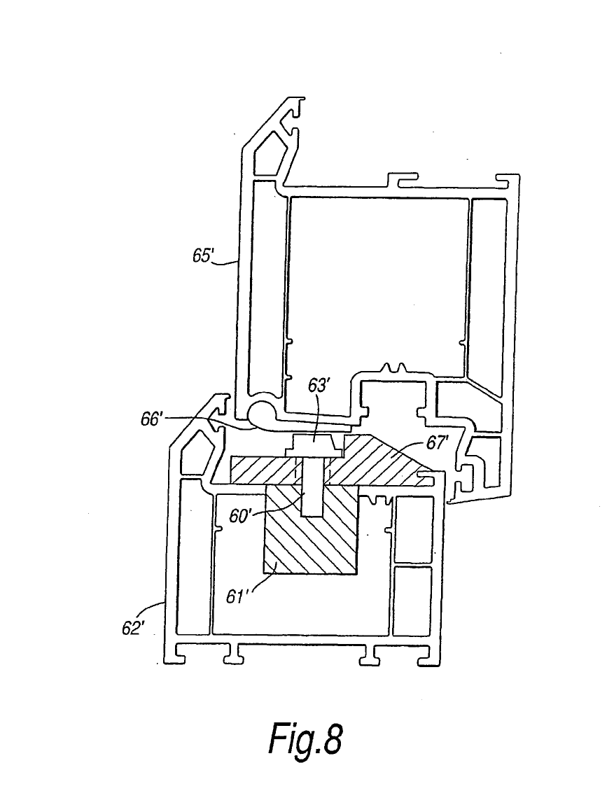

FIG. 8 is an illustration of a pneumatically controlled lock shown in the unlocked or inoperative position in association with a door sash;

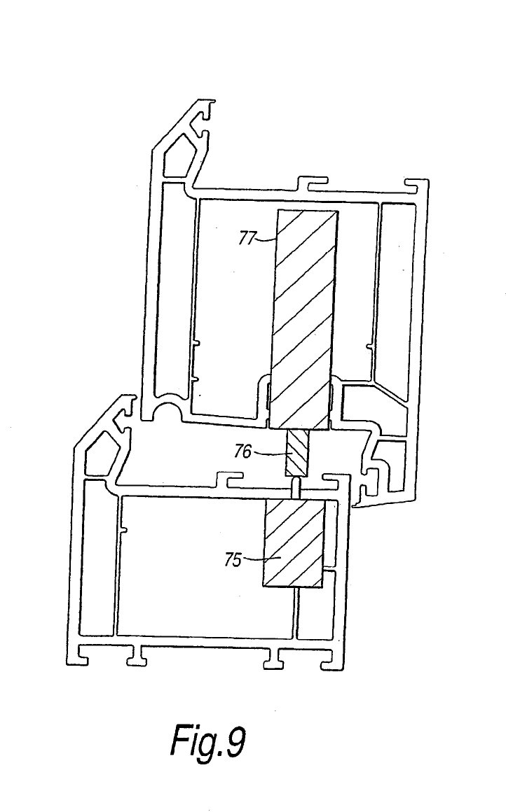

FIG. 9 is an illustration of a manually actuable door locking mechanism with an associated pneumatic valve;

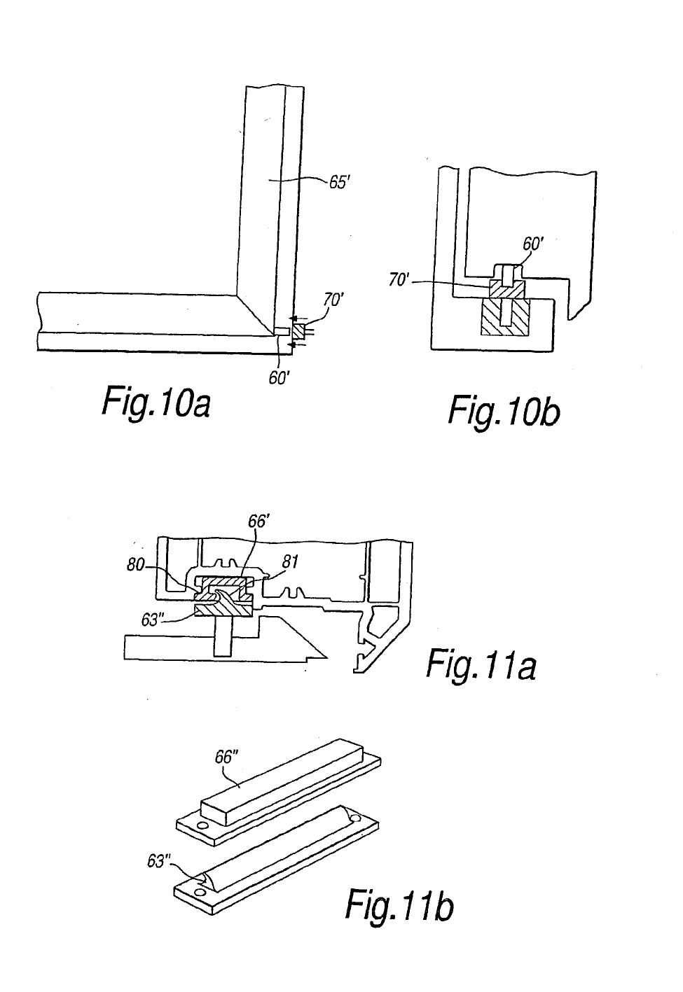

FIGS. 10a and 10b show an illustrative front and cross-sectional locking arrangement according to one aspect of the present invention; and

FIGS. 11a,b and c show illustrative views of a door and window locking mechanism having a preferred configuration.

Referring to FIG. 1, there is shown a building structure 10, in the example of the drawings, a two storey dwelling, having an exterior wall structure including an outer wall 12, and an inner wall 14, with a cavity 15 between the inner 14 and outer 12 walls.

The structure 10 includes a void being a loft space 17 above the upper level of the cavity 15, beneath a roof structure 18.

The building structure 10 has external doors, one example being shown at 20, and windows, an upstairs window being indicated at 22 and a downstairs window being indicated at 24 for illustrative purposes.

In accordance with the invention a control system is installed in the building structure 10, which in this example has remote locking, and fire/smoke detection and intruder sensor and telecommunications and curtain actuating functionality.

To that end, the building structure 10 has provided within it a plurality of remotely operable locks, e.g. window lock 25 for the upstairs window 22, a window lock 27 for the downstairs window 24, and a lock 26 for the door 20. Of course in a practical installation only some windows and/or doors may have locks although preferably for highest security, all windows and doors of the structure 10 would have remotely operable locks.

Further, the building structure 10 has installed therein smoke/fire detectors 28, intruder sensor 30, and a plurality of telecommunications terminals two of which are indicated at 31 (downstairs) and 32 (upstairs).

Yet further, the building structure 10 has installed therein an operator input unit indicated at 35, located at a convenient position for operator input, i.e. adjacent the door 20. In this example the unit 35 includes a keypad by means of which an operator may input a secure PiN number to achieve control of the locks 25-27, and intruder sensing functionally, and if desired of the telecommunications functions of the structure 10 as indicated by the examples given below.

The building structure 10 includes a floor/ceiling structure 38 between the upper 39 and lower storeys 40, which includes a ceiling/floor space 41.

Externally of the building structure 10 there is provided an alarm unit 45 which may be arranged to sound an audible and/or visible alarm in the event of a fire or intruder being detected

Within the void 17 there is installed a central control unit 50 which in this example is a microprocessor controlled control unit which is adapted to respond to control signals e.g. from the operator input unit 35, inputs from the Locks 25, 26, 27, from the intruder sensors 30 and the fire/smoke detectors 28 to actuate the alarm unit 45 when appropriate, as hereinafter described.

Conventionally, each of the alarm/lock etc. functions of the. building structure would be individually controlled, although it is known to use telecommunication facilities to alert the authorities in the event of an intruder being detected. However, the control system described is an integrated system in which the central control unit 50 controls all the control functions described herein which are installed in the structure 10.

In accordance with the invention control lines to the various remote operating units, i.e. the locks 25-27, the detectors 28, the sensors 30, and the operator input unit 35, are installed without having to chase the control lines in plasterwork on, or on the surface of, the inner wall 14. This is achieved by using the cavity 15 between the inner 14 and outer 12 walls, which may readily be utilised as the central control unit 50 is located in the void 17 which extends above the level of the top of the cavity 15, as indicated by line A. Thus the various control lines can be passed down (or if more convenient, up) the cavity 15 to enable connections to be made between the central control unit 50 and the various remote operating units 25-28,30,35.

The various control lines may be inserted into the cavity 15 by means of a cavity insertion tool, which includes an elongate tube with a pointed end. The tool may be inserted into the cavity 15 from the void 17, pointed end first, such that it extends vertically downwards through the cavity 15. The insertion tool may be used as a conduit through which one or more of the various control lines may then be passed.

In order to determine when the insertion tool has reached the required vertical depth inside the cavity, e.g. when the end of the insertion tool is adjacent to one of the various remote operating units 25-28,30,35, a probe may be inserted horizontally into the cavity 15 via an internal window reveal. The probe may include a miniature camera connected to a viewing monitor and appropriate illumination means, such that the user may view inside the cavity 15 to locate the end of the insertion tool.

A wire may then be passed from the void 17 through the insertion tool, and a first end of the wire may be collected by the probe, for example, by means of magnets, and thus drawn out of the cavity 15. A second opposite end of the wire is retained within the void 17. The first end of the wire may be connected to one or more control lines, and a user may then pull the second end of the wire in order to draw the wire out of the cavity, and to draw the control line(s) into the cavity. The or each control line may then be connected to a remote operating unit 25-28,30,35 at a first end, and to the control unit 50 at a second end.

In the example indicated, control lines c I to c3 extend between and connect the central control unit 50 to the respective locks 25-27. In the illustrated example, each of the windows 22, 24 and the door 20 are in the same (front) elevation and the control lines c1, c3, c2 thereto are passed down the cavity 15 of the front elevation. It will be appreciated that frames of the door 20 and windows 22, 24 close the cavity 15. Hence by mounting the locks 26-27 in the frames, access can be gained to the control lines c1 to c3 in the cavity 15, particularly but not exclusively during a window/door replacement operation, to enable electrical and/or pneumatic connections to be made between the control lines c1 to c3 and the locks 25-27.

A control line c4 between the fire/smoke detector 28 of the upper storey 39, can simply be installed by passing the control line c4 through an opening provided in a ceiling 41 of the upper storey 39. However a control line c5 between the central control unit 50 and the fire/smoke detector 28 of the lower storey 40, is installed in the cavity 15, then along the floor/ceiling space 41 by providing an opening 42 for the control line c5 in the inner wall 14 at the level of the floor/ceiling structure 38.

Similarly a control line c6 for the intruder detector 30 of the lower storey 40 is installed in the cavity 15 and passes through an opening 43 provided in the inner wall 14 at the level of the floor/ceiling structure 38, then along the ceiling space 41 to the detector 30 which in this example is ceiling mounted. However, where the detector 30 is alternatively inner wall 14 mounted rather than ceiling mounted as indicated, electrical connection to the control line c6 may be achieved by providing an opening through the inner wall and passing the control line c6 through the opening.

A single control line c7 extends between the central control unit 50 and each of the communications terminals 31, 32. Thus the terminals 30, 31 may be provided on a net. The control line c7 is installed in the cavity 15 and the terminals 30,31 are inner wall 14 mounted. Where the terminal 32 is required within an upper storey room in a position where it cannot be inner wall 14 mounted, the control line c7, or a control line particularly for the terminal 32, may extend from the cavity 15 along the floor/ceiling space 41 to a desired position. Where the terminal 31 of the lower storey 40 is required in a position where it cannot be inner wall 14 mounted, the control line c7, or a control line particularly for the terminal 31, may extend beneath a floor 52 of the lower storey 40 to a desired position.

It can be seen that the building structure 10 also includes power operated curtains 55 which are mounted on a rail 56 above the window 24 of the lower storey 40. The curtains 55 are power opened and closed by a motive means indicated at 57 under the control of the central control unit 50, so that the curtains 55 may be opened and closed automatically, for example on a timed basis, or under the control of an operator as hereinafter described.

A control line c8 extends between the motive means 57 and the control unit 50 in the void 17. The control line c8 is installed in the cavity 15. An opening is made through the inner wall 14 adjacent the motive means 57, to enable electrical connection to be made between the motive means 57 and the control line c8 therefor.

A control line c10 between the operator input unit 35 and the central control unit 50 is installed in the cavity 15, and an opening may be made through the inner wall 14 to enable electrical connections to be made between the control line c 10 and the operator input unit 35.

It will be appreciated that by utilising the method of the invention and locating the central control unit 50 in the void 17 which extends above the level of the cavity 15, the control lines c1-c10 can all be hidden without requiring any chasing into plasterwork of the inner wall 14, or surface mounting of the lines e.g. in conduit. The control lines c1-c10 can conveniently be passed down (or up) the cavity to access positions adjacent remote operating units of the lower storey 40.

Where the building structure 10 includes interior walls with cavities, these cavities too may be utilised for the installation of control lines. Where the cavities of such internal walls open into the void 17, e.g. internal walls of the upper storey 40, or supporting internal walls, control lines may be passed down (or up) the internal wall cavities from the void 17. Where the cavities of such internal walls are only accessible from the floor/ceiling space 41, control lines may be installed in the cavity 15 of the outer wall structure, along the floor/ceiling space 41, and in the cavities of the internal walls. Thus any of the remote operating units including the operator input unit 35 may be mounted on such internal walls, as desired.

As shown, a control line cl 1 extends between the central control unit 50 and the alarm unit 45, along the cavity 15 for a short way. Alternatively, the control line c11 may extend down through the eaves of the structure, as desired.

By virtue of the various control lines c1 to c11 all being hidden and the central control unit 50 being located in the void 17, it will be appreciated that interference with the control system e.g. by an intruder, is difficult. Thus a building structure 10 with a control system installed in accordance with the invention may be made very secure.

The remote operating units 25-28, 30, 35 may be operated using hydraulic or pneumatic means, in which case the control lines c1 to c11 may include pipes carrying operating fluid such as compressed air or hydraulic fluid. The control unit 50 may in this case include a pump or compressor, a fluid reservoir, and a processor means, the processor means controlling one or more electronic valve(s) which regulate(s) fluid flow through the control lines c1 to c11.

Alternatively, the remote operating units 25-28, 30, 35 may be electrically operated, in which case the control lines c 1 to c ii may include electrically conductive wires. The control unit 50 may include a processor means and a power supply, the processor means being adapted to send electrical signals along the control lines c1 to c11 in order to operate the operating units 25-28, 30, 35

The locks 25-27 are preferably locks of the kind which each include a bolt which may be extended, e.g. by solenoid action, into co-operation with an opening wing i.e. casement, sash, vent, or door, to prevent the window/door being opened until the bolt is withdrawn. The bolt may be urged towards a locked or unlocked condition by a resilient biasing means such as a spring, or may be powered in both directions of movement.

The structure 10 described in our co-pending applications is particularly suited to installation of a central locking mechanism according to the installation method described above. However, aspects of our invention are not limited to that type of structure, and the invention could be fitted, for instance, during the initial construction of a building when the options for the method of installation of the system are not as restricted as they are when the system is fitted to an existing structure.

Examples of a pneumatically operated lock 25 are illustrated in FIGS. 2, 3, 4, and 5.

The lock 25 includes a cylindrical piston 60, a first end of which is mounted in a pneumatic cylinder 61. A generally rectangular piston head 63 mounted on a second opposite end of the piston 60.

The pneumatic cylinder 61 is mounted within a frame 62 of a window or door, and the piston 60 passes from the cylinder 61 through an aperture in a window guide 67 mounted on the frame 62. Compressed air is fed from a control line c1-c11 into the pneumatic cylinder 61 via an inlet means 64. Variations in air pressure within the pneumatic cylinder 61 causes movement of the piston 60 from a locked condition, illustrated in FIGS. 2, 4 and 5, to an unlocked condition, as illustrated in FIG. 3, and vice versa.

When in the locked position, the piston head 63 co-operates with a frame 65 of an opening wing such as a casement, sash, vent or door, to prevent opening of the window or door. A groove 66 is provided within the frame 65, and, when in the locked condition, the piston head 63 is located within, and engages with the groove 66. The groove 66 may be provided by a euro-groove within the frame 65. Alternatively, the piston head 63 may co-operate with a keep located in a euro-groove or friction stay area of the frame 65.

The locks 25-27 may be positioned such that the piston 60 extends vertically or horizontally into the frame 65.

An example of an electrically operated lock 25 is illustrated in FIG. 7. In this case the lock 25 includes a cylindrical bolt 68, which is located within a solenoid 69 along a longitudinal axis of the solenoid 69. The solenoid 69 is located within a frame 62 of a window or door, and is retained in position within the frame 62 by means of a retaining means 70. The retaining means 70 is fastened to the frame 62 by means of a fastening means such as a spigot 71, and may be made as a moulding from a polymer such as nylon for example.

A latch means 72 is pivotally connected to the retaining means 70 about an axis A positioned close to a first end of the latch means, the second end contacting the bolt 68. Thus when the bolt 68 moves, the latch means 72 pivots about the pivot axis A. The latch means 72 may be made from aluminium or steel. When an electrical current is supplied to the solenoid via a control line c1 to c11, the solenoid 69, the bolt 68 moves along the longitudinal axis of the solenoid 69 from an unlocked condition to a locked condition.

When in the locked condition, the bolt 68 pushes the latch means 72 into engagement with a catch means 73 attached to a frame 65 of an opening wing, for examples, a casement, sash, vent or door, to prevent opening of the window or door, as illustrated in FIG. 7. The catch means 73 made be made from cast or extruded aluminium, and may be attached to the frame 65 by a fastening means 74 such as a screw.

When in the unlocked condition, the latch means 72 does not come into engagement with the catch means 73, and therefore the window or door may be opened.

Turning now to FIG. 8, a main or master door is shown in illustrative cross section. With the door in its closed position the piston head 63′ of a locking mechanism is aligned with a keep or groove 66′ and on actuation of the piston 60′, the piston head 63′ engages with the keep or groove 63′ to secure the door sash 65′ in the closed position. The relative location of the euro-groove in the door assembly means it is preferable to utilise a bespoke keep or groove, but the euro-groove could be utilised if preferred. The same arrangement could be used in association with a window lock if it is preferred not to utilise the euro-groove or a euro-groove is not present.

If the locking mechanism is provided on the main or master door of a building structure, it might be preferable to disengage the pneumatic locks automatically when the manually actuable lock in the door is unlocked. This mechanism provides for access to the building if the pneumatic locks cannot be deactivated via the control unit for any reason. For instance, if the control unit is controlled by means of a key fob or access code, loss of the key fob or the access code could make it impossible for even authorised personnel to gain access to the building.

With this in mind, a sensor is provided in association with the manually actuable lock. The sensor deactivates the pneumatic lock or locks on the main or master door when the manually actuable lock is opened. This development might also allow entry to the building to de-arm the alarm system via an internal control pad or station. In the example shown in FIG. 9, the sensor takes the form of a pneumatic trigger 75; which allows the release of pressurised fluid from the pneumatic lock or locks associated with the door when the bolt 76 of the door lock 77 is withdrawn.

In FIG. 310, an alternative arrangement for a window lock is illustrated, although the arrangement could be applied equally to a door.

The window is secured in the closed position by a piston 60′ which is actuated manually by a control lever or other mechanism on the inside of the building. The piston 60′ engages in a pneumatically operated keep or receptacle 70 as shown in FIG. 3b. The keep 70′ is housed in the window frame and is preferably moved under the action of a pneumatic ram between an operative and an inoperative position along an axis parallel to the central longitudinal axis of the piston 60′. On deactivation of the pneumatic system the keep 70 is removed from the path of the piston 60′ to allow the window or door to open or close. This arrangement combines the general security offered by a shoot bolt arrangement with the advantages of a central locking system described previously.

In a preferred arrangement showing in FIG. 11, the piston head 63″ has a wavelike cross-sectional profile. The inner face 80 of the piston head relative to the window or door sash is generally upright, but has a concavity or inset adapted to cooperate with the confronting surface of an associated keep, which may be integral with the window or door frame, or, as shown in FIG. 11, provided as a separate component. During the life of a window or door, changes in the position of the window or door sash relative to the frame may take place. For example, the relative positions could change due to the settling of the building over time, or wear on the door or window furniture. The concavity or inset provides for positive engagement between the surfaces that abut when an attempt is made to open a locked window or door, and reduces the chance that the window or door could be forced opened due to changes in the relative alignment of the sash and frame. A similar result can be achieve by providing formations on the piston head and the confronting surface of the associated keep which positively engage when the piston head is moved into the operative position.

A change in the relative positions of the sash and frame may also affect the ease with which the door or window is closed. For example, if part of the piston head stands proud of the frame when it is retracted it may impede the closing of the door or window. To reduce the possibility that it may do so the outer face 81 of the piston head relative to the window or door sash is shaped such that contact between the sash or the associated keep and the piston head will urge the piston head towards the retracted position. In the preferred example, the outer face 81 of the piston head is inclined in the direction of movement of the sash when the window is closed.

In all the preferred embodiments of the locking mechanism, the piston head is generally rectangular in plan view, with the major side of the piston being orientated transverse to the direction of opening and closing of the window or door sash. The major sides of the piston head form the surfaces with abut the sash or associated keep or slot, and by orientating the major surface in the specified direction a more positive engagement is made between piston head and the sash or keep.

Further features of the invention, which are not illustrated, will now be described.

Instead of or in addition to power operated curtains 55, blinds may be provided which are opened and closed under the control of the central control unit 50. The central control unit 50 may provide for communication between the communications terminals 31, 32 within the building structure 10, and/or with an external telecommunications or other external communications network. This may be achieved by providing a control line from the central control unit 50 to a telephone wire (indicated at W) to the building structure 10, or via a microwave or radio (mobile telephone) type link.

Thus the control unit 10 may be remotely controllable, i.e. from outside the building structure 10 by means of the telecommunications network. Alternatively, the control system may be remotely controlled by broadcast signals from a terrestrial or satellite based transmitter, although security protocols would be required to protect the security functions of the system.

The operator input unit 35 may be used to set/unset the alarm functionality of the control system when then operator leaves the building structure 10, or to set the alarm functionality for a zone or zones within the structure, e.g. in the simple system illustrated, the upstairs or downstairs zone, whilst the operator is in the structure. The operator input unit 35 may be used remotely to operate each, or only some of the locks 25-27, so that the structure 10 may be made secure from a single control point within the structure 10. The control system may sense if any of the locks 25-27 is operated while the window or door is open and may indicate this to the operator at the operator control unit 35, so that remedial action may be taken. Also, when the alarm function is set, if any window or door is subsequently opened, this may be sensed by the system and the alarm unit 45 operated in response. Thus the locks 25-27 may include contact type sensors.

Instead of in addition to the window locks 25, 27, a sensor may be provided to detect if the window is broken, and signal the central control unit 50 appropriately.

The operator input unit 35 may be used to open/close the curtains 55 and/or to set a time for the automatic opening/closing of the curtains 55. The operator input unit 35 may be used to affect the telecommunications functionality of the system, for example to disable some or all outgoing calls, or to set an answering machine. Additionally, or instead of the operator input unit 35 being a keypad, this may include a signal detector to detect an infra-red/radio or the like signal broadcast from an operator. Thus an operator may carry a key fob with a signaling unit. If desired, a receiver for such broadcast control signals may be provided on the exterior of the building structure 10 and/or separately from the operator input unit 35, and connected to the central control unit 50 by a control line which may be at least partly installed in cavity 15 of the outer wall structure. The receiver may be adapted to receive a PIN number from the key fob or other broadcast means, which may thus have a keypad.

In each case the central control unit 50, and the control system generally via the control lines c1-c1 1, may be powered from the mains within the building structure 10, with a battery backup in the event of power failure, as is well known in the art of alarm technology.

Various other modifications may be made without departing from the scope of the invention.

It will be appreciated that the building structure 10 shown is purely illustrative and that in practice a building structure would have doors/windows on other elevations. The invention may be applied to a structure 10 having more or less than two storeys.

In the example described, the control lines c1-c1 1 are all for conveying electrical signals. In another example, at least some of the control lines may be pipes for operating fluid such as compressed air or even hydraulic fluid. It is envisaged that particularly where one or more of the locks 25-27 is of the kind in which there is a spring or other resilient biasing means normally urging e.g. a bolt to an unlocked condition, and power is required to move the bolt to a locked position against the force of the spring, or vice versa, that conveniently, compressed air may be provided to the lock to hold the bolt against the spring force. The pipe may be closable by an electrically operated valve e.g. situated in or adjacent to the central control unit 50, so that when a pressure has been established in the pipe, the pressure is maintained by closing the valve to retain the bolt in a position in opposition to the spring. Thus the central control unit 50 may also include a fluid pump which is operable to pressurise the fluid, and maintain fluid pressure in any pipe control means.

As mentioned above, utilising the present invention, the building structure 10 may be made very secure. To allow access for a fire-fighter or other emergency personnel, means are required to enable any locks 25-27, to be released. For example, in the event of one or more of the fire/smoke detectors 28 being activated, the locks 25-27 may all automatically be released and the alarm unit 45 operated. The emergency services may automatically be called by operating the telecommunications functionality of the control system, if required.

Otherwise, each lock 25-27 may have an associated emergency release, such as a keypad or the like located adjacent the relevant door or window, to allow the operator to egress the structure through a door or a window in an emergency. On the exterior of the structure 10, in a location which is not readily accessible, e.g. in the eaves, there may be provided an emergency release such as is used to activate a fire alarm, which emergency release when activated may release all˜the locks 25-27 or at least one of the locks, and simultaneously, the alarm unit 45 may be activated.

Of course if desired, more than one operator input unit 35 may be provided within the structure 10, for example a second may be provided upstairs, to allow (zoned) actuation of the alarm and lock functions of the control system at night.

The invention may be utilised during the construction or major refurbishment of the building structure 10, by installing control lines within wall cavities as the walls are built and where required, in floor ceiling spaces 41 of a building during construction, although the invention particularly lends itself to use for providing a control system in an existing and internally decorated structure.

The method of the invention need not be utilised for providing fire/smoke detection capability and intruder sensing capability and remote locking and unlocking capability and remote/automatic curtain/blind opening and closing capability, but may be utilised to provide a control system for controlling only one or any combination of these capabilities, or an alternative control system function, including heating, lighting and cooking or even the control of automatically opening and closing of door and windows e.g. using power operated hinges.

In some building structures 10, to enable access to be gained to the cavities 15 of the outer wall structure, roof tiles may need temporarily to be removed. To facilitate installation of control lines in the cavity 15, special tools may be required to illuminate the cavity, and to bring the end of a control line to a position adjacent a remote operating unit, and through the inner wall 14

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention-in diverse forms thereof. Further, the skilled will appreciate that modifications to the invention could be made without departing from the scope of the claims. For instance, the central control system might incorporate a ‘panic’ or alarm facility which allow an authorised user to deactivate the or each locking mechanism in the event of emergency. The panic facility could be operated from a key fob used in conjunction with the central control system, from the central control system itself or from a fixed remote sensor conveniently positioned in the building, e.g. by the bedside of the user, and in communication with the central control system.

1. A central locking system for a building having at least one window or door, the system comprising a central control unit in communication with a storage means for retaining pressurised fluid, the storage means being in fluid communication with at least one locking mechanism operable in response to a signal from the central control unit to the storage means to move between an inoperative position in which the opening and closing of the associated door or window is unimpeded and an operative position in which the opening and closing of the door or window is impeded.

2. A central locking system according to claim 1, wherein the locking mechanism is associated with a window or door has a euro-groove for accommodation of window or door furniture, and the locking mechanism cooperates with the euro-groove in the operative position to impeded opening and closing of the window or door.

3. A central locking system according to claim 2, wherein the locking mechanism comprises a protrusion mounted on the frame of the window or door and adapted to cooperate with the cavity defined by the euro-groove.

4. A central locking system according to claim 1, wherein the locking mechanism comprises a pair of inter-engaging formations mounted on the frame and the sash of the window or door respectively.

5. A central locking system according to claim 4, wherein the formations comprise a recess and a protrusion adapted to engage the recess when the locking mechanism is in the operative position.

6. A central locking system according to claim 3 or 5, wherein the protrusion is moveable along a primary axis between an extended and a retracted position in which the locking mechanism is in the operative and the inoperative position respectively, and a plurality of support means guide the movement of the protrusion between the extended and the retracted positions.

7. A central locking system according to claim 6, wherein the support means are configured substantially to prevent movement or rotation of the protrusion away from the primary axis.

8. A central locking system according to anyone of claims 3, 5, 6 or 7 wherein the protrusion has a main face for abutment with a surface of the window or door sash or an associated keep when an attempt is made to open the window or door when the locking mechanism is in the operative position, the main face engaging with or protecting at least partially beyond the level of the abutting surface substantially to prevent the window sash riding over the protrusion on application of a force to the window or door.

9. A central locking system according to claim 8, wherein the main face of the protrusion is generally concave.

10. A central locking system according to anyone of claims 1 to 9, wherein the locking mechanism is urged from the operative position to the inoperative position by biasing means.

11. A central locking system according to anyone of claims 1 to 10, wherein the locking mechanism is provided with sloped abutment surfaces for aiding the accurate location of the window or door sash within associated frame.

12. A central locking system according to claim 11, wherein the sloped abutment surface is integrally formed with the locking mechanism.

13. A central locking system according to claim 1, wherein the locking mechanism includes a keep or housing adapted to cooperate with a manually operable bolt to impede the opening or closing of the window or door, and the locking mechanism is pneumatically moveable between the operative and inoperative positions of the locking mechanism.

14. A central locking system according to claim 13, wherein the window or door can be opened when the locking mechanism is in the inoperative position irrespective of the position of the bolt means.

15. A central locking system according to any one of claims 1 to 14, wherein the window or door is provided with manually actuable fail-safe release means to allow a person within the building to move the locking mechanism from the operative position to the inoperative position in the event of emergency.

16. A central locking system according to any one of claims 1 to 15, wherein a sensor is associated with the locking mechanism to provide a signal to the central control unit indicative of the position of the locking mechanism.

17. A central locking system according to claim 16, wherein a visual and/or audible alarm means is activated when the signal from the sensor indicates to the central control system that the locking mechanism is in the operative position when the central control system expects the locking mechanism to be in the inoperative position.

18. A central locking system according to any one of claims 1 to 17, wherein a pneumatic valve is associated with a manually actuable door locking mechanism of a master door such that unlocking the master door locking mechanism moves the or each pneumatic locking mechanism associated with that door to the inoperative position.

19. A central locking system according to any one claims 1 to 18, wherein at least one of the a temperature and/or smoke detector and/or movement and/or infra-red sensor or other intruder sensor is provided.

20. A central locking system according to any one of claims 1 to 19, wherein at least on fire and/or smoke detector is operably connected to the central control unit and the control unit being configured such that the or each pneumatic locking mechanism is moved to the inoperative position in the event of detection of fire and/or smoke.

21. A central locking system according to any one of claims 1 to 20 comprising a communications terminal for communicating with the central control unit, to other communications terminals of the system internally of the building and/or to a communications network external of the building.

22. A central locking system according to any one of claims 1 to 21, installed by the method of any one of the foregoing method claims.

23. A central locking system for a building having at least one window or door, the system comprising a central control unit in communication at least one locking mechanism operable in response to a signal from the central control unit to move between an inoperative position in which the opening and closing of the associated door or window is unimpeded and an operative position in which the opening and closing of the door or window is impeded, the door or window with which the locking mechanism is associated has a euro-groove for accommodation of window or door furniture, and the locking mechanism cooperates with the euro-groove in the operative position to impeded opening and closing of the window or door.

24. A central locking system according to claim 23, wherein the locking mechanism comprises a protrusion mounted on the frame of the window or door and adapted to cooperate with the cavity defined by the euro-groove.

25 A method of providing a control system for a building structure of the kind having an exterior wall structure including an inner wall and an outer wall and a cavity between the inner and outer walls, the system including a central control unit which is connected by control lines to remote operating units including at least one operator input unit, each remote operating unit being located within a boundary of the exterior wall structure, the method being characterised by the step of installing control lines at least partially within the cavity so as to extend between the central control unit and at least one of the remote operating units.

26. A method according to claim 25, wherein the central control unit is situated in a void extending above the upper level of the cavity between the inner and outer walls.

27. A method according to claim 26 characterised in that the void in which the central control unit is installed is a loft space of the building structure, or where the building structure includes an attic, a space either above a ceiling of the attic or in an attic floor space.

28. A method according to claim 25 26 or 27 characterised in that the method includes installing a control system which enables at least one window/door lock remotely to be actuated.

29. A method according to claim 28 characterised in that at least one of the remote operating units is a lock and the method includes mounting the lock in a door or window frame and connecting the lock with a respective control line by accessing the control line direct from the cavity.

30. A method according to claim 29 characterised in that the lock has a locking bolt which is extendible into engagement with the respective door or window casement sash or other wing in response to, or in the absence of a control signal along the respective control line, from the central control unit.

31. A method according to any one of claims 25 to 26 characterised in that the method includes installing at least one remote operating unit being a temperature and/or smoke detector and/or movement and/or infra-red sensor or other intruder sensor, by mounting the detector/sensor on the inner wall of the building structure or a ceiling thereof providing an opening through the inner wail to the cavity and passing the control line therefor through an opening in the inner wall to enable connection to be made to the remote operating unit.

32. A method according to any one of claims 25 to 31 characterised in that the method includes installing at least one remote operating unit being a contact type intruder sensor which senses when a window or door is open or has been opened or broken, the method including mounting the sensor in a door or window frame and connecting the sensor to the respective control line by accessing the control line direct from the cavity.

33. A method according to any one of claims 25 to 32 characterised in that the method includes installing at least one remote operating unit being a communications terminal, by means of which communication may be made via the central control unit, to other communication terminals of the system internally of the building structure, and/or an external telecommunications network.

34. A method according to claim 33 characterised in that the communications terminal is mounted on the inner wall of the building structure, and the method includes providing an opening through the inner wall to the cavity and passing the control line therefore through the opening.

35. A method according to any one of claims 25 to 34 characterised in that where the control system has both fire/smoke detection functionality and remotely operable locks, the method includes configuring the control system to operate to cause the locks to unlock in the event of detection of a fire/smoke.

36. A method according to any one of claims 25 to 35 characterised in that the method includes installing at least one remote operating unit being a blind/curtain actuating means, providing a connection between a respective control line and the actuating means by passing the control line through an opening between the inner wall and the cavity.

37. A method according to any one of claims 25 to 36 characterised in that the method includes installing remote operating units being locks and/or fire/smoke detectors and/or intruder sensors and/or communications terminals and/or blind/curtain actuating means.

38. A method according to any one of claims 25 to 37 characterised in that the method includes installing the operator input unit and connecting the unit to the central control unit by installing a control line in the cavity so that the line extends from the central control unit, to a convenient position within the building for operator input.

39. A method according to any one of claims 25 to 38 characterised in that the operator input unit includes a keypad by means of which an operator may input a secure PIN number to control the system, and/or a key operated lock, and/or a broadcast signal receiving unit for receiving signals broadcast by an operator to control the system.

40. A method according to any one of claims 25 to 39 characterised in that the method includes installing a remote control signal receiver unit by means of which control signals from a satellite or terrestrial based transmitter, may be provided to the central control unit for controlling the system.

41. A method according to any one of claims 25 to 40 characterised in that the method includes installing at least one remote operating unit on or in an internal wall of the building structure, and providing connection thereto from the central control unit via a respective control line by installing the control line therefor in a cavity of the internal wall, and/or by installing the control line therefor in the cavity of the external wail structure of the building, through a floor or ceiling space, and through a cavity of the internal wall.

42. A method according to any one of claims 25 to 41 characterised in that the method includes installing control lines including electrical wires for carrying electrical signals, and/or pipes for carrying operating fluid.

43. A method according to claim 42 characterised in that where the control lines include electrical wires and the remote operating units are electrically operated.

44. A method according to claim 42 characterised in that where the control lines are pipes the method includes installing a fluid pump to pressurise the fluid and remote operating units which are fluid operated.

45. A method according to claim 44 characterised in that means are provided to maintain a fluid pressure in the pipe control lines to maintain a remote operating unit in an operative or inoperative condition in opposition to a resilient biasing means which is operable to bias the remote operating unit into an inoperative or operative condition respectively.

46. A method according to claim 44 or 45, wherein the pump is installed in a void which extends above the upper level of the cavity between the inner and outer walls

47. A method according to anyone of claims 25 to 46 wherein the control lines are installed within the cavity.

48. A method of installing a control system in a building structure substantially as hereinbefore described with reference to the accompanying drawing.

49. A control system installed in a building structure by the method of any one of claims 25 to 48.

50. A building structure having installed therein a control system according to claim 49.

51. Any novel feature or novel combination of features described herein and/or in the accompanying drawings.

52. A locking mechanism for a building central locking system comprising a pneumatically operated protrusion moveable along a primary axis between an extended and a retracted position in which the locking mechanism respectively impedes and allows the opening and closing of an associated door or window, and a plurality a support means to guide the movement of the protrusion between the extended and the retracted positions, the support means being configured substantially to prevent movement or rotation of the protrusion away from the primary axis.

53. A locking mechanism according to claim 52 wherein the protrusion has a main face for abutment with a surface of the window or door sash or an associated keep when an attempt is made to open the window or door when the locking mechanism is in the operative position, the main face engaging with or protecting at least partially beyond the level of the abutting surface substantially to prevent the window sash riding over the protrusion on application of a force to the window or door.

54. A locking mechanism according to claim 53, wherein the main face of the protrusion is generally concave.

55. A locking mechanism according to anyone of claims 52 to 54, wherein the locking mechanism is urged from the operative position to the inoperative position by biasing means.

56. A locking mechanism according to anyone of claims 52 to 55, wherein the locking mechanism is provided with sloped abutment surfaces for aiding the accurate location of the window or door sash within associated frame.

57. A locking mechanism according to claim 56, wherein the sloped abutment surface is integrally formed with the locking mechanism.

58. A locking mechanism according to anyone of claims 52 to 57, wherein the protrusion comprises a member elongate in a direction perpendicular to the primary axis.
